(19) United States
(12) Patent Application Publication
(10) Pub. No.: US 2006/0256989 A1
(43) Pub. Date: Nov. 16, 2006

(54) Hearing prosthesis comprising rechargeable battery information

(76) Inventors: Henrik Bagger Olsen, Kgs Lyngby (DK); Henrik Bendsen, Copenhagen V (DK)

Correspondence Address: CANTOR COLBURN, LLP, 55 GRIFFIN ROAD SOUTH, BLOOMFIELD, CT, 06002, US

(21) Appl. No.: 10/550,114

(22) PCT Filed: Mar. 15, 2004
(86) PCT No.: PCT/DK04/00169

§ 371 Date: May 18, 2006

(30) Foreign Application Priority Data
Mar. 17, 2003 (DK) PA 200300408

(51) Int. Cl. H04R 25/00

(52) U.S. Cl. 381/323; 381/314

(57) ABSTRACT

A hearing prosthesis is disclosed with comprises memory means for storing charging control information associated with charging of a rechargeable battery cell that functions as a power source for the hearing prosthesis. Also, a rechargeable hearing aid system is disclosed which comprises a common communication interface adapted to transmit charging control information from the hearing prosthesis to the charger so as to allow the charger to adapt its charging parameters to a variety of different types of rechargeable batteries.

### FIELD OF THE INVENTION

The present invention relates to a hearing prosthesis, which comprises memory means for storing charging control information associated with charging of a rechargeable battery cell that functions as a power source for the hearing prosthesis. Another aspect of the invention relates to a rechargeable hearing aid system which comprises a common communication interface adapted to transmit charging control information from the hearing prosthesis to the charger so as to allow the charger to adapt its charging parameters to a variety of different types of rechargeable batteries.

### BACKGROUND OF THE INVENTION

Today's hearing prostheses are typically powered by miniature 1.3 Volt Zinc-air cells that have capacities somewhere between 100 and 500 mAh which allows about 1 week of operation of the hearing prosthesis with a typical user's utilisation pattern. The large consumption of these one-time battery cells is a significant expense for the user of the hearing aid and a hazard for the environment. Furthermore, the Zinc-air cells posses less than optimal voltage and source impedance characteristics since both of these parameters vary significantly with battery age and temperature.

Rechargeable batteries in hearing prostheses are known from e.g. DE 297 12 244 U and U.S. Pat. No. 6,310,960, and recharging of batteries in implants, such as a cardiac pacemaker, is disclosed in U.S. Pat. No. 6,227,204, in which a charging current detector and control means are included in the implant to control the charging current of the battery.

Efficient use of rechargeable batteries in hearing prostheses requires that the charging process is controlled so that the capacity and lifetime of the battery is preserved as well as possible. If the battery is charged with a constant high charging current, the battery will be worn out rather fast, as recharging of the battery will take place e.g. each day and each recharging cycle wears on the battery. Thus, it is an object of the present invention to provide recharging of the battery of a hearing prosthesis in which the charging process may be controlled according to a set of charging control information associated therewith, so as to improve the quality of the charging process.

### DESCRIPTION OF THE INVENTION

According to a first aspect of the invention, there is provided a hearing prosthesis comprising
a microphone adapted to generate an input signal in response to received acoustic signals,
a data processor adapted to process the input signal in accordance with a predetermined processing algorithm to generate a processed output signal,
an output transducer for converting the processed output signal into a user perceivable output signal,
rechargeable battery connections adapted to receive a rechargeable battery and operatively connected to battery charging means, and
connecting means for releasable connection to an external power source to provide charging power for the rechargeable battery,
   wherein the hearing prosthesis comprises memory means storing charging control information associated with charging the rechargeable battery.

The data processor or processing means may comprise one or several processors and its/their associated memory circuitry. The processor preferably comprises a Digital Signal Processor (DSP), which has been adapted to provide signal-processing tasks required by the predetermined processing algorithm as well a number of so-called household tasks such as monitoring and handling the communication interface and I/O signals and ports. The processing means may comprise a commercially available, or even proprietary, microprocessor, which may be adapted to handle the household tasks, which mostly involve logic operations and decision-making.

The DSP may be a software programmable type adapted to execute the predetermined processing algorithm to deliver or provide a processed output signal to the user of the hearing prosthesis. According to that embodiment of the invention, control of the operation of the DSP is provided by a predetermined set of program instructions stored in an associated program RAM area.

The algorithm parameters are preferably intermediately stored in a volatile data memory area of the processor means such as a data RAM area during execution of the main signal-processing algorithm.

The memory means, which is adapted to store the charging control information associated with charging the rechargeable battery preferably comprises a non-volatile memory area such as an EEPROM/Flash memory area, or a RAM with a back-up or secondary power supply source. The non-volatile memory area secures the charging control information is retained during power supply interruptions. Power supply interruptions may for example be caused by a discharged rechargeable battery or by the removal or replacement of the rechargeable battery. The memory means may advantageously be operatively connected to the data processor and may more preferred be the same memory means that stores the relevant instructions for the data processor to perform the predetermined processing algorithm.

The battery charging means preferably comprises a pair of electrical terminals located on an exterior surface of the hearing prosthesis. The pair of electrical terminals may be accessible from the housing by a battery charger, which conveys charging current and voltage through a corresponding pair of electrical terminals on the battery charger. Alternatively, the battery charging means may comprise a contact-free power transfer system between the hearing prosthesis and the battery charger based on near-field electromagnetic coupling between a coupled pair of coils or based on an intensive light source in the battery charger and a photoelectric element in the hearing prosthesis.

The rechargeable battery may comprise a Li-Ion, NiCad or NiMH battery such as a single NiMH cell with a nominal voltage of about 1.25 Volt and nominal storage capacity between 10 and 100 mAh or more preferably between 15 and 40 mAh.

The hearing prosthesis may in a preferred embodiment comprise data communication means for releasable establishing data communication with an external unit. The Data communication means may, among other possible applications, be used to update the charging control information stored in the memory means when a new rechargeable battery is installed in the hearing prosthesis. The memory means may in a particular embodiment be arranged to communicate charging control information to the external unit by means of the data communication means, and the prosthesis comprises in this embodiment connecting means for connecting an externally provided charging current to the rechargeable battery connections.

It is advantageous if the data processor of the hearing prosthesis furthermore is adapted to provide charging control instructions to control the operation of charging current regulator means in accordance with the charging control information so as to control a charging cycle of the rechargeable battery. The charging current regulator may be installed in the hearing prosthesis or more preferably in the charger unit so as to reduce the equipment installed in the hearing prosthesis itself. In that case, the data processor is arranged to communicate charging control instructions to the external unit by means of the data communication means, and the prosthesis comprises connecting means for releasable connecting an externally provided charging current to the rechargeable battery connections.

According to a preferred embodiment of the invention, the hearing prosthesis comprises charging current regulator means adapted to charge the rechargeable battery in accordance with the charging control information, and connecting means for releasable connection of an external charging power supply to the charging current regulator. An attractive feature of this embodiment is that battery charger may be simplified to a fixed DC voltage supply. The charging current regulator means may advantageously comprise the processor of the hearing prosthesis and, optionally, an A/D converter adapted to sample charging voltage and/or current in order to control the charging process. In a particular embodiment, an external charging control means is employed to control the charging current regulator means, and the memory means is arranged to communicate charging control information to the external unit by means of the data communication means and the charging current regulator means is arranged to receive charging control instructions from the external unit by means of the data communication means.

The charging current regulator means may comprise a resistor and processor controllable switch element such as bipolar or MOS transistor, or the charging current regulator means may alternatively comprise a pulse width modulator for controlling a magnitude of a charging current applied to the rechargeable battery. Other suitable charging current regulator means may naturally be employed as well.

In a particular embodiment of the present invention, the hearing prosthesis comprises means for recurrently storing data related to the charging and de-charging of said rechargeable battery in said memory means. These historical data may be used to determine the optimal charging algorithm for the specific rechargeable battery, and the data thus become a part of the charging control data or information.

The present invention furthermore relates to a rechargeable hearing prosthesis system comprising:
a hearing prosthesis as disclosed above,
a charger unit having connection means for establishing releasable connection to the connection means of the hearing prosthesis and means for providing charging power via said connection means.

The charger unit may comprise charging control means, which may have a detection circuitry for sensing whether or not a hearing prosthesis is connected to the charging circuitry. In particular, the charging control means of the charger may comprise a default charging procedure for charging the rechargeable battery of the hearing prosthesis in case invalid or no charging control information is received, whereby a hearing prosthesis always may be charged, even though the information from the prosthesis for some reason may not be transmitted to the charger unit.

The charger unit may furthermore comprise a DC voltage measuring circuitry for determining the DC voltage of a rechargeable battery of a hearing prosthesis connected thereto, and the charging control means is adapted to control the charging procedure based on the measured DC voltage or in particular its rate of change over time. In particular, a derivative of the change of battery DC voltage over time is for several types of batteries an indication of that the battery is fully charged and the charging control means should switch to a trickle charge state to avoid overcharge. An alternative or supplemental stop criteria for the charging process can be based on a fixed DC voltage limit of the battery voltage such as a voltage of about 1.45-1.52 Volt for a NiMH cell at room temperature.

In a particularly preferred embodiment of the rechargeable hearing prosthesis system, the charger unit comprises a battery compartment adapted for holding one or more batteries to power the charger unit during charging cycles of a hearing prosthesis connected thereto. Thus, the charger unit may be used to charge the hearing prosthesis regardless of the access to a public electric supply network or mains outlet.

Alternatively, the charger unit may consist of an interface unit for interfacing the hearing prosthesis with an external power supply for supplying power at a more or less constant voltage to another device, such as a mobile telephone, a mobile computer, a palm pilot, or from a standard power outlet in a car. The hearing prosthesis may for this embodiment be arranged to measure the incoming voltage and adjust the control of the current regulator as a consequence hereof.

Furthermore, the charger unit may consist of an interface unit for interfacing the hearing prosthesis with a battery driven external power supply, such as a mobile telephone, a mobile computer, a palm pilot, etc. The power consumption for charging the hearing prosthesis is insignificant as compared to the power stored in the batteries of such devices.

It is furthermore advantageous if the charger unit is adapted to reset the data processor of the hearing prosthesis by a reset command sent via the data communication means. Thereby, errors in the function of the data processor due to a rechargeable battery voltage less than a safe lower limit may be avoided by securing that the predetermined processing algorithm is reloaded from a non-volatile memory. A particular attractive embodiment of the invention is provided if the charger unit is adapted to monitor the DC voltage of the rechargeable battery and first issue the reset command when the DC voltage is larger than lower limit.

### BRIEF DESCRIPTION OF THE DRAWINGS

Embodiments of the present invention are disclosed with reference to the enclosed drawing, of which

FIG. 1 is a schematic diagram of a charging circuit for charging a rechargeable battery,

FIG. 2 is a schematic diagram of a preferred embodiment of a software programmable DSP based hearing prosthesis system according to the invention, in which the charger unit comprises a power supply,

FIG. 3 is a schematic diagram of an embodiment, in which the charger unit comprises a power supply and a charging current regulator,

FIG. 4 is a schematic diagram of an embodiment, in which the charger unit comprises a power supply, a charging current regulator and a charging control means, and

FIG. 5 is a block diagram of a hearing prosthesis according to an embodiment of the present invention.

### DETAILED DESCRIPTION OF EMBODIMENTS

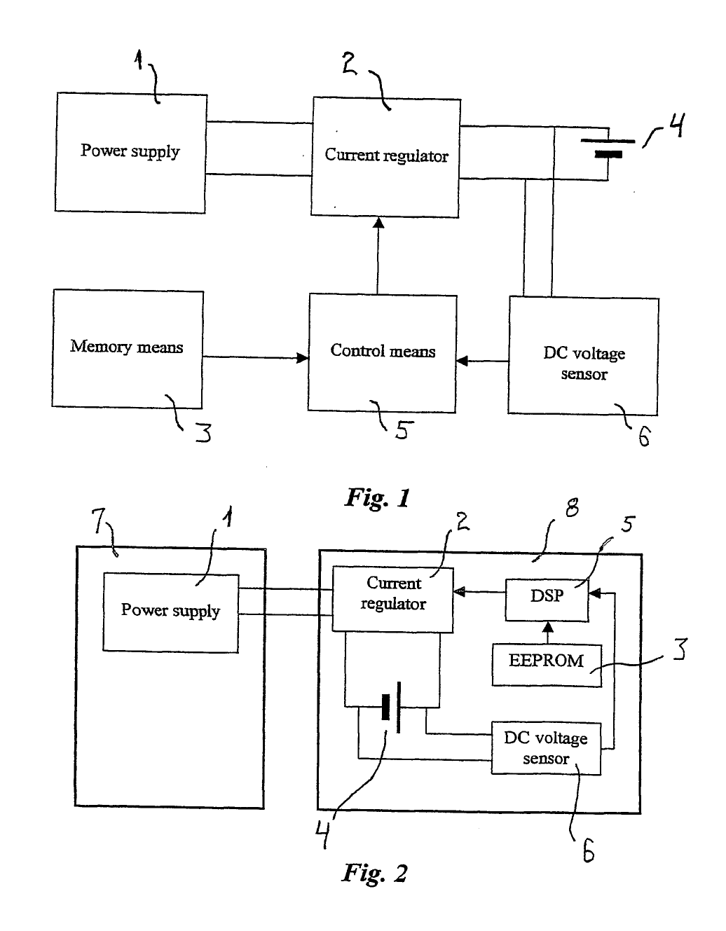

A schematic diagram of a typical charging circuit is shown in FIG. 1, comprising a power supply 1 for providing a constant voltage and/or a constant current to the charging current regulator 2. The memory means 3 comprises the charging control information for the specific rechargeable battery 4 to be recharged. The charging control information is transmitted to the charging control means 5, and a DC voltage sensor measures 6 the voltage over the battery 4 and provides an output accordingly to the control means 5. The control means 5 provides charging control information to the charging current regulator 2 so as to control the operation thereof, based on the output of the DC voltage sensor measures 6 and the charging control information, so as to control the charging current and/or charging voltages provided from the charging current regulator 2 to the battery 4. A temperature sensor for measuring the temperature of the battery during the recharging operation and producing an output accordingly to the charging control means may also be provided. Details of the operation of a charging circuit, including examples of charging control information and charging algorithms for control of the charging operations may be found in U.S. Pat. No. 6,075,339 by Reipur et al. and other sources which are known to the skilled person.

In FIG. 2, a first embodiment of a software programmable DSP based hearing prosthesis system according to the invention is shown, in which the charger unit 7 comprises a power supply 1 which supplies the hearing prosthesis 8 via a releasable connection. The charging current regulator 2 is arranged in the hearing prosthesis 8 and is controlled by the control means 5, which is the digital signal processor DSP which also is the signal processor which process the input from the microphone and provides an output for an output transducer of the hearing prosthesis 8 during normal operation of the hearing aid. The charging algorithm information for the battery 4 is stored in the memory means 3 EEPROM of the hearing prosthesis 8, which also stores the specific information or set of program instructions for the processing algorithm for the DSP for processing the input from the microphone.

In a relatively simple, and thus inexpensive and compact, embodiment, the DC voltage sensor may be omitted and the charging algorithm adapted to charge with a substantially fixed charging current over a predetermined time interval to fully charge the battery. For a NiMH cell with a nominal capacity of 15 mAh, the fixed charging current may selected to about 1.5 mA for 12-16 hours or about 4.5 mA for 4-5 hours. Preferably, the charging process comprises a trickle charge state subsequent to the normal charging process to maintain the rechargeable battery fully charged.

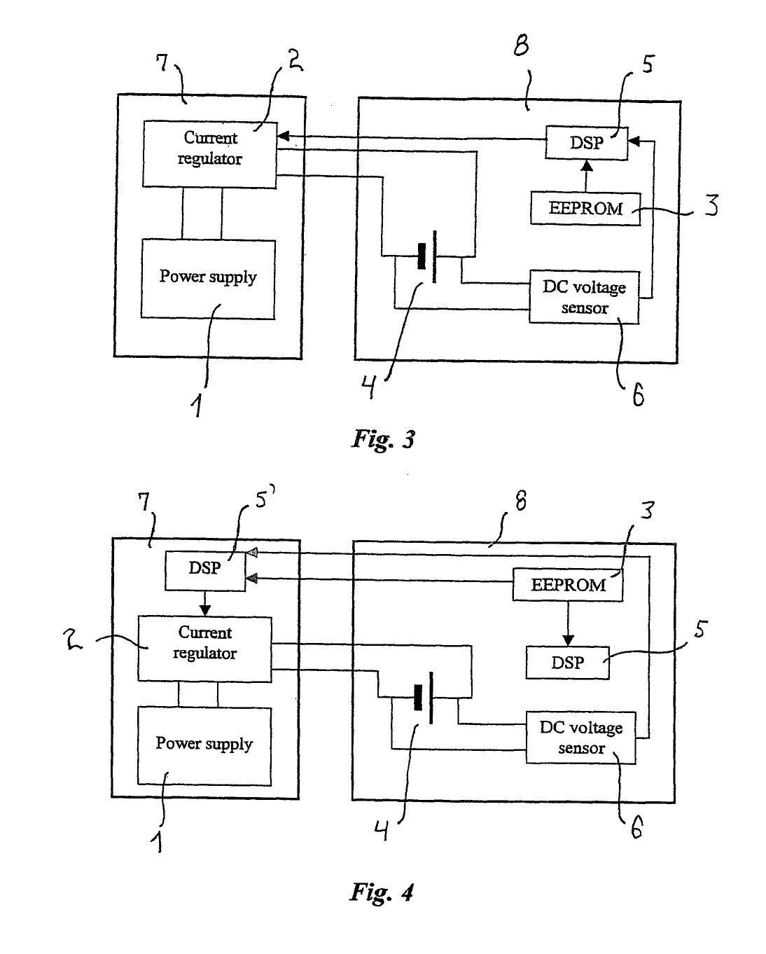

In FIG. 3 a second embodiment is shown, in which the charger unit 7 comprises a power supply 1 as well as a charging current regulator 2, which is controlled by charging control instructions generated by the DSP 5 of the hearing prosthesis 8 and are transmitted to the charger unit 7 via a releasable data communication connection.

In FIG. 4 a third embodiment is shown, in which the charger unit 7 comprises a power supply 1, a charging current regulator 2 and a charging control means 5′, which receives the charging control information from the EEPROM 3 of the hearing prosthesis 8 and are transmitted to the charger unit 7 via a releasable data communication connection.

A hearing prosthesis with which the present invention may be employed comprises a conventional hearing aid microphone that receives an acoustic signal from a surrounding listening environment. The microphone provides an analogue input signal on terminal MIC1IN of a proprietary A/D integrated circuit. The analogue input signal is amplified in a microphone preamplifier and applied to an input of a first A/D converter of a dual A/D converter circuit comprising two synchronously operating converters of the sigma-delta type. A serial digital data stream or signal is generated in a serial interface circuit and transmitted from terminal A/DDAT of the proprietary A/D integrated circuit to a proprietary Digital Signal Processor circuit (DSP circuit). The DSP circuit comprises an A/D decimator which is adapted to receive the serial digital data stream and convert it into corresponding 16 bit data words at a lower sampling rate for further processing in a DSP core. The DSP core has an associated program Random Read Memory (program RAM), data RAM and Read Only Memory (ROM). The signal processing of the DSP core is controlled by program instructions read from the program RAM. A serial bi-directional 2-wire programming interface allows a host programming system to communicate with the DSP circuit, over an serial interface circuit, and a commercially available EEPROM to perform up/downloading of signal processing algorithms and/or associated algorithm parameters.

1. A hearing prosthesis comprising
a microphone adapted to generate an input signal in response to received acoustic signals,
a data processor adapted to process the input signal in accordance with a predetermined processing algorithm to generate a processed output signal,
an output transducer for converting the processed output signal into a user perceivable output signal,
rechargeable battery connections adapted to receive a rechargeable battery and operatively connected to battery charging means, and
connecting means for releasable connection to an external power source to provide charging power for the rechargeable battery,
wherein
the hearing prosthesis comprises memory means storing charging control information associated with charging the rechargeable battery.

2. A hearing prosthesis according to claim 1, wherein said memory means comprise non-volatile memory means.

3. A hearing prosthesis according to claim 1, wherein said memory means are operatively connected to said data processor.

4. A hearing prosthesis according to claim 3, wherein said memory means are arranged to contain instructions defining the predetermined processing algorithm.

5. A hearing prosthesis according to claim 1, comprising data communication means for releasable establishing data communication with an external unit.

6. A hearing prosthesis according to claim 5, wherein the memory means is arranged to communicate charging control information to the external unit by means of the data communication means, and the prosthesis comprises connecting means for connecting an externally provided charging current to the rechargeable battery connections.

7. A hearing prosthesis according to claim 1, wherein the data processor is adapted to provide charging control instructions to control the operation of charging current regulator means in accordance with the charging control information so as to control a charging cycle of the rechargeable battery.

8. A hearing prosthesis according to claim 7, wherein the data processor is arranged to communicate charging control instructions to the external unit by means of the data communication means, and the prosthesis comprises connecting means for releasable connecting an externally provided charging current to the rechargeable battery connections.

9. A hearing prosthesis according to claim 1, comprising charging current regulator means and connecting means for releasable connection of an external charging power supply to the charging current regulator.

10. A hearing prosthesis according to claim 9, wherein the memory means is arranged to communicate charging control information to the external unit by means of the data communication means and the charging current regulator means is arranged to receive charging control instructions from the external unit by means of the data communication means.

11. A hearing prosthesis according to claim 9, wherein the charging current regulator means comprises a resistor and processor controllable switch element such as bipolar or MOS transistor.

12. A hearing prosthesis according to claim 9, wherein the charging current regulator means comprises a pulse width modulator for controlling a magnitude of a charging current applied to the rechargeable battery.

13. A hearing prosthesis according to claim 1, comprising means for recurrently storing data related to the charging and de-charging of said rechargeable battery in said memory means.

14. A rechargeable hearing prosthesis system comprising:
a hearing prosthesis according to claim 1,
a charger unit having connection means for establishing releasable connection to the connection means of the hearing prosthesis and means for providing charging power via said connection means.

15. A rechargeable hearing prosthesis system according to claim 14, wherein the hearing prosthesis comprises data communication means for releasable establishing data communication with the charger unit, and
the charger unit comprises a charger data communication means adapted to releasable establish data communication with the data communication means of the hearing prosthesis.

16. A rechargeable hearing prosthesis system according to claim 15, wherein the data processor of the hearing prosthesis is adapted to provide charging control instructions to control the operation of charging current regulator means in accordance with the charging control information and communicate said charging control instructions to the charger unit by means of the data communication means, and the charger unit is adapted to receive the charging control instructions from the hearing prosthesis and provide a charging current to the hearing prosthesis via the charger unit connection means by means of a charging current regulator means.

17. A rechargeable hearing prosthesis system according to claim 15, wherein the hearing prosthesis is adapted to transmit the charging control information to the charger unit by means of the data communication means, and the charger unit is adapted to receive the charging control information from the hearing aid, the charger unit comprising a charging current regulator adapted to provide a charging current to the hearing prosthesis via the charger unit connection means, and charging control means adapted to control the operation of the charging current regulator means based on the received charging control information.

18. A rechargeable hearing prosthesis system according to claim 17, wherein the charging control means of the charger comprises a microprocessor adapted to control the charging current regulator means and/or the charger data communication means.

19. A rechargeable hearing prosthesis system according to claim 17, wherein the charging control means comprises a detection circuitry for sensing whether or not a hearing prosthesis is connected to the charging circuitry.

20. A rechargeable hearing prosthesis system according to claim 19, wherein the charging control means of the charger comprises a default charging procedure for charging the rechargeable battery of the hearing prosthesis in case invalid or no charging control information is received.

21. A rechargeable hearing prosthesis system according to claim 16, wherein the charger unit comprises DC voltage measuring circuitry for determining the DC voltage of a rechargeable battery of a hearing prosthesis connected thereto, and the charging control means is adapted to control the charging procedure based on the measured DC voltage.

22. A rechargeable hearing prosthesis system according to claim 14, wherein the charger unit comprises a battery compartment adapted for holding one or more batteries to power the charger unit during charging cycles of a hearing prosthesis connected thereto.

23. A rechargeable hearing prosthesis system according to claim 15, wherein the charger unit is adapted to reset the data processor of the hearing prosthesis by a command sent via the data communication means.
